(19) United States
(12) Patent Application Publication
(10) Pub. No.: US 2012/0188627 A1
(43) Pub. Date: Jul. 26, 2012

(54) SMART WINDOW AND SMART WINDOW SYSTEM USING THE SAME

(75) Inventors: YING-PING CHEN, Hsinchu (TW); Hsiao-Wen Zan, Hsinchu (TW); Chuang-Chuang Tsai, Hsinchu (TW); Yung-Sheng Chang, Hsinchu (TW); Chia-Chun Yeh, Hsinchu (TW); Ted-Hong Shinn, Hsinchu (TW)

(73) Assignee: E Ink Holdings Inc., Hsinchu City (TW)

(21) Appl. No.: 13/104,100

(22) Filed: May 10, 2011

(30) Foreign Application Priority Data
Jan. 21, 2011 (TW) 100102306

(51) Int. Cl. G02F 1/153; G02F 1/03

(52) U.S. Cl. 359/275; 359/245

(57) ABSTRACT

A smart window includes a windowpane, at least one sensor and a wireless signal transceiver. The sensor is disposed on the windowpane and configured for detecting an environmental factor and accordingly outputting a sensing signal. The wireless signal transceiver is disposed on the windowpane and electrically connected to the sensor. The wireless signal transceiver is configured for further transmitting the sensing signal from the sensor. A smart window system includes the aforementioned smart window. The smart window and the smart window system adopt wireless communication manner to transmit the sensing signals, and thereby the smart window system has an overall modulation to an environmental factor.

### FIELD OF THE INVENTION

The present invention generally relates to a smart system, and more particularly to a smart window and a smart window system using the same.

### BACKGROUND OF THE INVENTION

With a capability of performing an intelligent modulation to environmental factors, smart window system is widely used in some specific areas such as various types of buildings and transportations. Basically, sensors disposed in a conventional smart window system are either configured to perform a self-response or transmit sensing signals to a modulating device via a wire communication manner. If these sensors are configured to have self-response functions and not transmit the sensing signals to the modulating device, it is difficult for the conventional smart window system to perform an effectual intelligent modulation to environmental factors. Alternatively, even these sensors are connected to the modulating device through a wire communication manner, the number and setup positions of these sensors in the conventional smart window system are easily restricted by an environmental condition.

Moreover, in a conventional smart window system, each one of the sensors is needed to be equipped with a modulating device, and there is no sensing signal transmission between more than one smart window in the conventional smart window system. Here, a conventional car smart window system is taken as an example. A conventional car smart window system includes multiple smart windows and multiple corresponding modulating devices. Each one of the smart windows includes an electrochromic glass and a light sensor. Each one of the light sensors is electrically connected to its corresponding modulating device. The light sensor is configured to detect the light strength and accordingly output a corresponding sensing signal to its corresponding modulating device, and thereby the modulating device can modulate the color of the corresponding electrochromic glass based on the received sensing signal. Therefore, a more comfortable environment is obtained inside the car. However, these light sensors work independently which indicates that there is no signal connection between these light sensors, so the conventional car smart window system accordingly cannot have an overall modulation to the environment inside the car through these modulating devices.

### SUMMARY OF THE INVENTION

The present invention provides a smart window with a wireless communication function.

The present invention further provides a smart window system adopting a smart window capable of transmitting a sensing signal via a wireless communication manner, and thereby the smart window system has an overall modulation to an environmental factor.

The present invention provides a smart window. The smart window includes a windowpane, at least one sensor and a wireless signal transceiver. The sensor is disposed on the windowpane and configured for detecting an environmental factor and accordingly outputting a sensing signal. The wireless signal transceiver is disposed on the windowpane and electrically connected to the sensor, and configured for further transmitting the sensing signal from the sensor.

In one embodiment, the above mentioned sensor is an organic-inorganic composite sensor.

In one embodiment, the organic-inorganic composite sensor includes at least a transparent oxide semiconductor thin film transistor.

In one embodiment, the wireless signal transceiver is an antenna which is implemented by at least a fine metal wire or at least a transparent electrode.

In one embodiment, an electric connection between the sensor and the wireless signal transceiver is realized by a transparent conductive material.

In one embodiment, the at least one sensor is at least one of an image sensor, a temperature sensor, a vibration sensor, a poison gas sensor and a bursting gas sensor.

The present invention further provides a smart window system. The smart window system includes at least one aforementioned smart window and a central monitoring device. The central monitoring device is configured for receiving the sensing signal from the wireless signal transceiver.

In one embodiment, the smart window system further includes at least one modulating device. The central monitoring device can control the modulating device according to the received sensing signal.

In one embodiment, the at least one modulating device is at least one of a central air conditioning device, an alarm device, a fire-fighting device and an electrochromic film.

In one embodiment, a number of the at least one smart window is multiple, and these smart windows can transmit signals via the wireless signal transceivers.

In the smart window and the smart window system of the present invention, because the transmission of sensing signal(s), which is produced and outputted from a sensor(s), from the wireless signal transceiver(s) to the central monitoring device is based on a wireless communication manner, thereby it is easier to setup the wireless signal transceiver(s) in the smart window and the smart window system without the restrictions of environmental or outer-shape factors. In addition, if the number of the smart window is multiple, these sensing signals, produced and outputted from more than one sensors, are capable of being transmitted between these smart windows via these wireless signal transceivers. Therefore, when the collected sensing signals are transmitted to the central monitoring device, the central monitoring device can perform an overall modulating action to the environmental factors according to the collected sensing signals, so as to facilitate an optimal modulating effect and an objective of power saving.

### BRIEF DESCRIPTION OF THE DRAWING

The above objects and advantages of the present invention will become more readily apparent to those ordinarily skilled in the art after reviewing the following detailed description and accompanying drawings, in which:

FIG. 1 is a diagram that schematically illustrates a smart window system in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

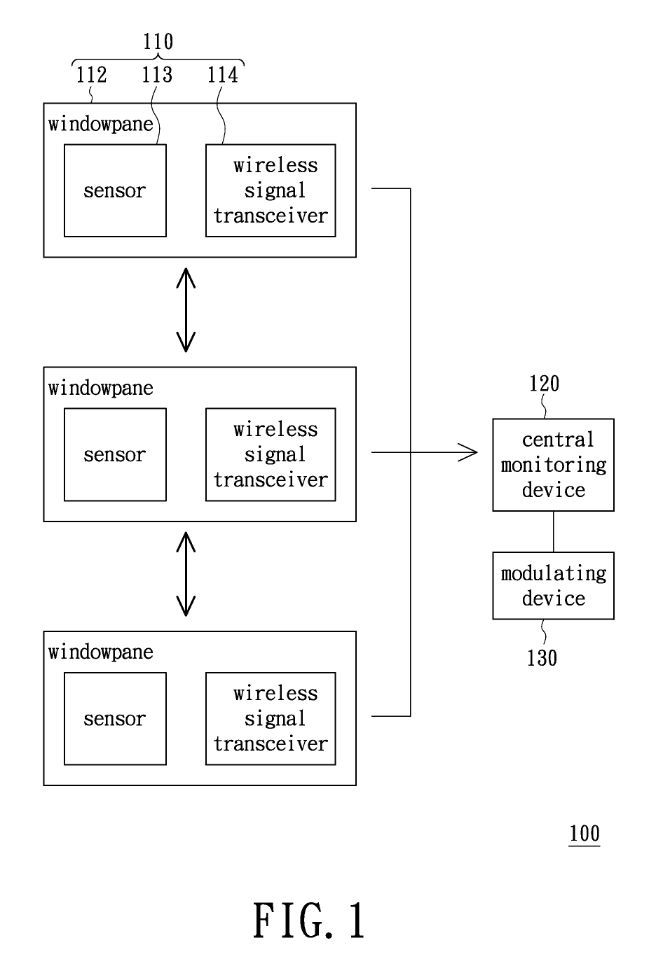

FIG. 1 is a diagram that schematically illustrates a smart window system in accordance with an embodiment of the present invention. As depicted in FIG. 1, the smart window system 100 includes at least one smart window 110 and a central monitoring device 120; here, a smart window system 100 containing more than one smart window 110 is taken as an example in the illustrative embodiment. As depicted in FIG. 1, each one of the smart windows 110 includes a windowpane 112, at least one sensor 113 and a wireless signal transceiver 114; here, each one of the smart window 110 includes for example one sensor 113. In each one of the smart window 110, the sensor 113 is disposed on the windowpane 112 and is configured to detect an environmental factor and accordingly output a sensing signal. The wireless signal transceiver 114 is also disposed on the windowpane 112 and electrically connected to its corresponding sensor 113, and is configured to further transmit the sensing signal from the corresponding sensor 113. Additionally, in one embodiment, these smart windows 110 are signal connected to each other through these wireless signal transceivers 114, and thereby the individual sensing signals can be transmitted between these smart windows 110.

In the present embodiment, the electric connection between the sensor 113 and its corresponding wireless signal transceiver 114 is realized by a transparent conductive material. The sensor 113 can be an image sensor, a temperature sensor, a vibration sensor, a poison gas sensor, or a bursting gas sensor, but it is not to limit the present invention.

In the present embodiment, the sensor 113 is an organic-inorganic composite sensor, but it is not to limit the present invention. The organic-inorganic composite sensor includes at least one transparent oxide semiconductor thin film transistor. Specifically, different types of sensors 113 respectively with specific functions can be manufactured via a modulation to the organic material in the organic-inorganic composite sensor. These different types of sensors 113 are configured to detect different kinds of environmental factors, such as an image, a temperature, a vibration, a poison gas or a bursting gas, etc.

As mentioned above, each one of the smart windows 110 may include more than one sensor 113. These sensors 113 for example may be configured to respectively detect different environmental factors and accordingly transmitting corresponding sensing signals to the central monitoring device 120. In addition, it is understood that one single sensor 113 in another embodiment may be configured to detect a combination of these different environmental factors.

In the present embodiment, the wireless signal transceiver 114, for example, is an antenna which is implemented by at least a fine metal wire or at least a transparent electrode. The wireless signal transceiver 114 adopts, for example, a radio-frequency (RF) communication manner for the transmission of the sensing signal, but it is not to limit the present invention. The wireless signal transceiver 114 and its corresponding sensor 113 can be firstly pre-disposed on a flexible printed circuit board (not shown) and the flexible printed circuit board is then further disposed on the windowpane 112. In another embodiment, the wireless signal transceiver 114 and its corresponding sensor 113 can be directly disposed on the windowpane 112. In addition, the wireless signal transceiver 114, the sensor 113, and the connection wires between thereof can be implemented by transparent material, so that the windowpane 112 has a wider view and a better light transmission.

In the present embodiment, the smart window system 100 may further include at least one modulating device 130 which is controlled by the central monitoring device 120 according to the received sensing signal. Here, the modulating device 130 can be any device capable of being controlled by the central monitoring device 120, such as a central air conditioning device, an alarm device, a fire-fighting device or an electrochromic film, but it is not to limit the present invention. As mentioned above, the smart window system 100 may include more than one modulating devices 130, and therefore, each individual modulating device 130 may be configured to perform a specific modulating action. In addition, it is understood that one single modulating device 130 in another embodiment may be configured to perform a combination of different modulating actions.

The smart windowpane 110 and the smart window system 100 in accordance with the present embodiment can be used in some specific areas such as a glass building, transportation or some other public places, but it is not to limit the present invention. As mentioned above, if the smart window system 100 includes more than one smart window 110, these individual sensing signals can be transmitted between these smart windows 110 via wireless signal transceivers 114. Therefore, after these individual sensing signals are collected and feed back to the central monitoring device 120, accordingly the central monitoring device 120 is able to control these modulating devices 130 to perform a corresponding modulating action(s) based on the received collected sensing signals.

Following is an exemplary application for illustrating some specific functions capable of being provided by the smart window system 100 in one embodiment, but it is not intended to limit the present invention.

In this example, the smart window system 100 is applied to a glass building and a corresponding modulating action is accordingly performed by the smart window system 100 based on a change of sunlight strength detected outside the glass building. The modulating device 130 in this example is a combination of a central air conditioning device and electrochromic films (not shown) which are disposed on the windowpanes 112. The smart window system 100 in this example includes more than one sensor 113, and these sensors 113 are temperature sensors.

In this example, when some sensors 113 detect a relatively high temperature resulted by an illumination of sunlight, these sensors 113 then transmit corresponding sensing signals to the central monitoring device 120, and thereby based on the received sensing signals the central monitoring device 120 is aware of the exact area where the sunlight is illuminating on the glass building. Therefore, the central monitoring device 120 can perform some corresponding modulating actions such as darkening the color of some specific electrochromic films, which are disposed on the windowpanes 112 and being illuminated by sunlight, so as to achieve a sunlight-block modulation. Furthermore, the central monitoring device 120 may control the central air conditioning device to output stronger cold air in the specific area where is being illuminated by sunlight.

In the aforementioned example, because a sunlight-block modulation is performed through the central monitoring device 120 controlling the electrochromic films to have a darker color, thereby the central air conditioning device consumes less electric power and an objective of power saving is achieved. In addition, because only a partial of electrochromic films, which are being illuminated by sunlight, are controlled to have a darker color, the sunlight illuminated to the inside of the glass building will not drop significantly. Thereby, only a partial of indoor light devices are needed to be turned on in the specific area if necessary, so an objective of power saving is also achieved.

To sum up, the smart window and the smart window system of the present invention at least have the following advantages:
1. In the smart window and the smart window system of the present invention, because the transmission of sensing signal(s), which is produced and outputted from a sensor(s), from the wireless signal transceiver(s) to the central monitoring device is based on a wireless communication manner, thereby it is easier to setup the wireless signal transceiver(s) in the smart window(s) or smart window system without the restrictions of environmental or outer-shape factors.
2. In the smart window in accordance with an embodiment of the present invention, because the sensor(s), the wireless signal transceiver(s) and the connection wire(s) between thereof are implemented by transparent material, so that the aforementioned devices or wire(s) do not affect the view and the light transmission of the windowpane.
3. In the smart window system in accordance with an embodiment of the present invention, these sensing signals, produced and outputted from more than one sensor, are capable of being transmitted between these more than one smart windows via these wireless signal transceivers. When the collected sensing signals are transmitted to the central monitoring device, the central monitoring device can perform an overall modulating action to the environmental factors according to the collected sensing signals, so as to facilitate an optimal modulating effect and an objective of power saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A smart window comprising:
a windowpane;
at least one sensor disposed on the windowpane, and the sensor being configured for detecting an environmental factor and accordingly outputting a sensing signal; and
a wireless signal transceiver disposed on the windowpane and electrically connected to the sensor, and the wireless signal transceiver being configured for transmitting the sensing signal from the sensor.

2. The smart window according to claim 1, wherein the sensor is an organic-inorganic composite sensor.

3. The smart window according to claim 2, wherein the organic-inorganic composite sensor comprises at least a transparent oxide semiconductor thin film transistor.

4. The smart window according to claim 1, wherein the wireless signal transceiver is an antenna which is implemented by at least a fine metal wire or at least a transparent electrode.

5. The smart window according to claim 1, wherein an electric connection between the sensor and the wireless signal transceiver is realized by a transparent conductive material.

6. The smart window according to claim 1, wherein the at least one sensor is at least one of an image sensor, a temperature sensor, a vibration sensor, a poison gas sensor and a bursting gas sensor.

7. A smart window system comprising:
at least one smart window, wherein each smart window comprises:
a windowpane;
at least one sensor disposed on the windowpane, and the sensor being configured for detecting an environmental factor and accordingly outputting a sensing signal; and
a wireless signal transceiver disposed on the windowpane and electrically connected to the sensor, and the wireless signal transceiver being configured for transmitting the sensing signal from the sensor; and
a central monitoring device configured for receiving the sensing signal which is outputted from the wireless signal transceiver.

8. The smart window system according to claim 7 further comprising at least one modulating device, wherein the central monitoring device controls the modulating device according to the received sensing signal.

9. The smart window system according to claim 8, wherein the at least one modulating device is at least one of a central air conditioning device, an alarm device, a fire-fighting device and an electrochromic film.

10. The smart window system according to claim 7, wherein a number of the at least one smart window is multiple, and the smart windows transmit signals to each other through the wireless signal transceiver.
